(19) United States
(12) Patent Application Publication
(10) Pub. No.: US 2025/0286807 A1
(43) Pub. Date: Sep. 11, 2025

(54) NETWORK DEVICE FOR OFFLOADING PACKET GENERATION TASK OF PROCESSOR TO HARDWARE ACCELERATION CIRCUIT AND RELATED NETWORK SPEED TEST METHOD

(71) Applicant: Airoha Technology (Suzhou) Limited, Suzhou City (CN)

(72) Inventor: Tao Liu, Suzhou City (CN)

(73) Assignee: Airoha Technology (Suzhou) Limited, Suzhou City (CN)

(21) Appl. No.: 19/070,491

(22) Filed: Mar. 4, 2025

(30) Foreign Application Priority Data
Mar. 8, 2024 (CN) 202410263548.9

(51) Int. Cl. H04L 43/50; H04L 43/0888; H04L 43/0894

(52) U.S. Cl. CPC H04L 43/50; H04L 43/0888; H04L 43/0894

(57) ABSTRACT

A network device includes a storage device, a processor and a hardware acceleration circuit. The storage device is arranged to store program codes. The processor is arranged to load and execute the program codes to perform the following operation: during a network speed test period, calculating at least one transmission parameter. The hardware acceleration circuit is arranged to provide a function of hardware-accelerated packet processing, wherein during the network speed test period, the hardware acceleration circuit is further arranged to refer to the at least one transmission parameter to self-generate a plurality of packets and send the plurality of packets to another network device for network speed test.

### BACKGROUND OF THE INVENTION

### 1. Field of the Invention

The present invention relates to a network speed test technique, and more particularly, to a network device that offloads a packet generation task of a processor (particularly, a processor with limited computing power) to a hardware acceleration circuit to meet the requirements of a network speed test of a high-speed network, and a related network speed test method.

### 2. Description of the Prior Art

Transmission control protocol (TCP) is a protocol belonging to the transport layer. Network devices at both ends of TCP connections can communicate with each other to ensure the accuracy of data transmission and control the transmission rate. For example, TCP uses two mechanisms, including acknowledgment and re-transmission mechanisms, to ensure the accuracy and reliability of TCP packets transmitted over the network. Therefore, the overall transmission procedure is less efficient, but it can ensure that TCP packets are correctly transmitted from a sender to a receiver. However, such a feature may not be necessary for certain applications. For example, a network speed test application actually does not care about the correctness of transmitted data contents. As network speeds continue to increase, conventional TCP-based network speed test applications may encounter bandwidth bottlenecks and seriously underestimate the actual user's network speed.

User Datagram Protocol (UDP) is another protocol belonging to the transport layer. TCP and UDP are both transport layer protocols. The main difference between TCP and UDP is whether they provide reliable transmission. TCP has a high degree of reliability. In contrast, UDP focuses on efficiency and does not care about packet loss. Therefore, a UDP-based network speed test application can be used as an alternative of a traditional network speed test application. However, regarding a network device that uses a processor with limited computing power, using the processor to generate each UDP packet required for an upload speed test consumes a lot of processor resources and memory resources. Even if the upload speed test can completely occupy the processor's working time, the maximum network speed that can be measured by the upload speed test is still far lower than the actual network speed due to the limited computing power of the processor, which fails to meet requirements of a network speed test of a high-speed network.

### SUMMARY OF THE INVENTION

One of the objectives of the claimed invention is to provide a network device that offloads a packet generation task of a processor (particularly, a processor with limited computing power) to a hardware acceleration circuit to meet requirements of a network speed test of a high-speed network, and a related network speed test method.

According to a first aspect of the present invention, an exemplary network device is disclosed. The exemplary network device includes a storage device, a processor, and a hardware acceleration circuit. The storage device is arranged to store a program code. The processor is arranged to load and execute the program code to perform following operation: during a network speed test period, calculating at least one transmission parameter. The hardware acceleration circuit is arranged to provide a function of hardware-accelerated packet processing, wherein during the network speed test period, the hardware acceleration circuit is further arranged to refer to the at least one transmission parameter to self-generate a plurality of packets and send the plurality of packets to another network device for network speed test.

According to a second aspect of the present invention, an exemplary network speed test method is disclosed. The exemplary network speed test method includes: executing a program code to calculate at least one transmission parameter; and using a hardware acceleration circuit with a function of hardware-accelerated packet processing for referring to the at least one transmission parameter to self-generate a plurality of packets and send the plurality of packets to another network device for network speed test.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a network device according to an embodiment of the present invention.

FIG. 2 is a diagram illustrating packet exchange between a sender and a receiver according to a TR-471 speed test protocol.

FIG. 3 is a diagram illustrating a packet format complying with the TR-471 speed test protocol.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

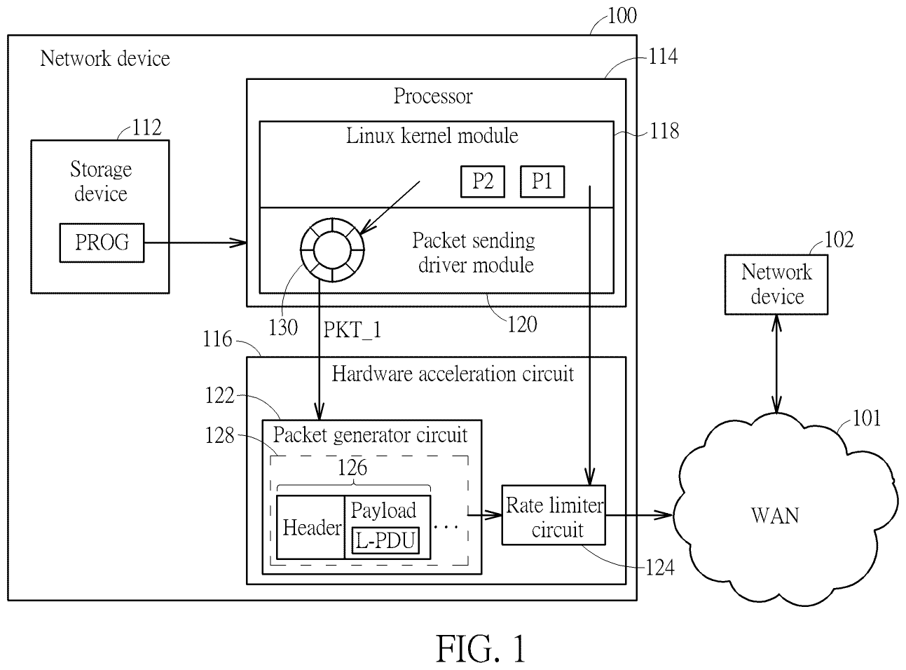

FIG. 1 is a diagram illustrating a network device according to an embodiment of the present invention. The network device 100 can perform data exchange with another network device 102 via a wide area network (WAN) 101. For example, the network device 100 may act as a client, and the network device 102 may act as a server. Therefore, the network device 100 can perform an upload network speed test by sending packets to the network device 102. In this embodiment, the network device 100 may be an optical network unit (ONU), but the present invention is not limited thereto. Any network device that employs the network speed test scheme proposed by the present invention falls within the scope of the present invention. The network device 100 includes a storage device 112, a processor 114, and a hardware acceleration circuit 116. Please note that only the components pertinent to the present invention are illustrated in FIG. 1. In fact, the network device 100 may include additional components to achieve other functions. The storage device 112 may be a memory or any component with data storage capability, and is arranged to store a program code PROG. For example, the program code PROG may include the program code of an operating system (OS). In this embodiment, the program code PROG may have multiple software modules, including (but not limited to) a Linux kernel module 118 and a packet sending driver module 120. The processor 114 is arranged to load and execute the program code PROG to control operations of the network device (e.g., client) 100. For example, the processor 114 may be a general purpose processor, and the Linux kernel module 118 may support a TR-471 speed test protocol (which is a UDP-based speed test protocol). Therefore, the processor 114 may perform operations related to software control in the network speed test scheme of the present invention through execution of the program code PROG (which includes the Linux kernel module 118 and the packet sending driver module 120).

In this embodiment, during a network speed test period, the processor 114 executes the program code PROG (particularly, Linux kernel module 118) to calculate at least one transmission parameter. For example, the processor 114 calculates a plurality of transmission parameters P1 and P2, and provides the transmission parameters P1 and P2 to the hardware acceleration circuit 116, wherein the transmission parameter P1 may be a sending rate (which is measured in bits per second (bps)) and the transmission parameter P2 may be a data amount (which is measured in bytes).

In addition, the network device 100 has the hardware acceleration circuit 116 for providing a function of hardware-accelerated packet processing. For example, the hardware acceleration circuit 116 may provide a hardware accelerated network address translation (HWNAT) function. In this embodiment, the hardware acceleration circuit 116 is a functional block implemented using pure hardware, and can additionally support the hardware operations required by the network speed test scheme of the present invention. For example, the hardware acceleration circuit 116 includes a packet generator circuit 122 and a rate limiter circuit 124. During the network speed test period, the hardware acceleration circuit 116 is further arranged to self-generate a plurality of packets 126 according to the transmission parameters (e.g., P1 and P2) provided by the processor 114 and send the packets 126 to another network device (e.g., server) 102 for network speed test (e.g., upload network speed test), wherein each packet 126 may be a UDP packet (i.e., a packet using the UDP protocol at the transport layer), where the UDP packet includes a UDP header and a UDP payload. In addition, each packet 126 carries a Load Protocol Data Unit (Load PDU) in a packet format that complies with the TR-471 speed test protocol. As shown in FIG. 1, the UDP payload of the UDP packet includes a Load PDU L-PDU. In addition, the packets 126 are sequentially written into a first-in first-out (FIFO) buffer 128 included in the packet generator circuit 122, and the FIFO buffer 128 sequentially outputs the packets 126 to the rate limiter circuit 124 for subsequent packet sending. Please note that packets may have different names at different layers of the network architecture. In the embodiment of the present invention, each of the packets 126 carries a Load PDU that complies with the TR-471 speed measurement protocol. In addition, each of the packets 126 uses the UDP protocol at the transport layer.

In this embodiment, the processor 114 is a processor with limited computing power, such as an ARM-based processor operating at 1.2 Gigahertz (GHz). Since the packet generation task of the processor 114 is very resource-intensive, the processor 114 cannot generate enough packets within the required time to test the actual speed of the network. To address this issue, the network device 100 of the present invention can offload the packet generation task of the processor 114 to the hardware acceleration circuit 116 for meeting requirements of a network speed test of a high-speed network. Further details about the network speed test scheme proposed by the present invention are described as below.

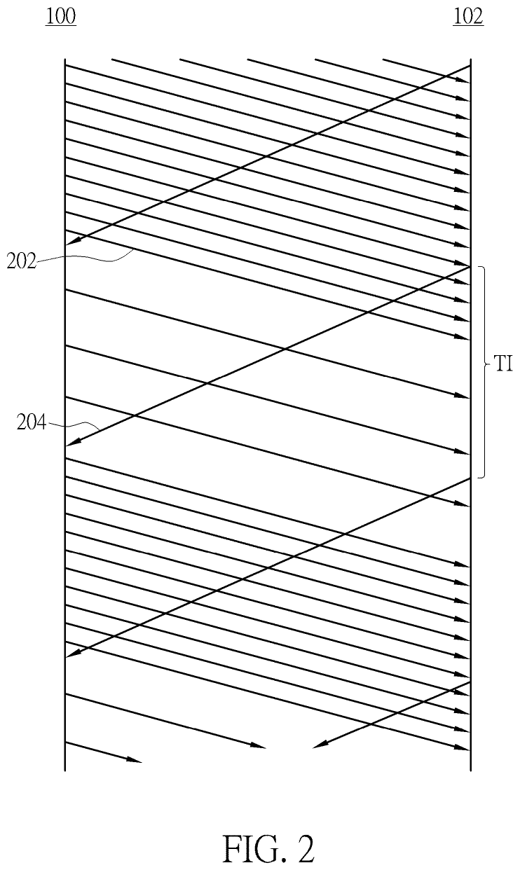

As mentioned above, the Linux kernel module 118 supports the TR-471 speed test protocol (which is a UDP-based speed test protocol). According to the TR-471 speed test protocol, the network device (client) 100 acts as a sender and the other network device (server) 102 acts as a receiver during a period of an upload network speed test. Please refer to FIG. 2. FIG. 2 is a diagram illustrating packet exchange between the sender and the receiver according to the TR-471 speed test protocol. During each trial interval (TI), the network device (sender) 100 transmits a plurality of Load PDUs 202 according to a sending rate set for the current TI. In addition, the network device (receiver) 102 parses each received Load PDU 202 to gather statistical information such as drop count, out of order, and round trip time (RTT). At the end of each TI, the statistical information is written into a Status Feedback PDU 204 and reported to the network device (sender) 100. Next, the network device (sender) 100 dynamically adjusts a sending rate to be used by the next TI according to the statistical information carried by the Status Feedback PDU 204.

In this embodiment, the program code (e.g., Linux kernel module 118) executed by the processor 114 parses the Status Feedback PDU 204 reported by the network device (receiver) 102, and calculates the transmission parameters (e.g., P1 and P2) for the next TI according to the statistical information carried by the Status Feedback PDU 204. Assuming that a duration of each TI is 10 milliseconds (ms) and a sending rate calculated by the program code (e.g., Linux kernel module 118) executed by the processor 114 for the next TI is 8 Gbps, the total data amount to be sent in the next TI can be calculated as 10 megabytes (MB) according to the product of the TI duration 10 ms and the calculated sending rate 8 Gbps (i.e., 8Gbps*10 ms). The processor 114 informs the hardware acceleration circuit 116 of the transmission parameter P1 (e.g., sending rate=8 Gbps) and the transmission parameter P2 (e.g., part of the total data amount 10 MB, such as the maximum UDP payload size of 64 kilobytes (KB) that is supported by the TR-471 speed test protocol; however, this is only an example, and in other embodiments, the transmission parameter P2 may use other values). In this embodiment, the speed limiter circuit 124 is informed of the transmission parameter P1 (e.g., sending rate=8 Gbps), and the packet generator circuit 122 is informed of the transmission parameter P2 (e.g., 64 KB).

The packet generator circuit 122 refers to the data amount (e.g., 64 KB) indicated by the transmission parameter P2 to determine how many packets (UDP packets) 126 needed to be self-generated and sent for achieving the objective of sending the data amount (e.g., 64 KB) as required by the processor 114 from the network device 100 to another network device 102, wherein the packet generator circuit 122 encapsulates a Load PDU (which includes a load header and a payload) into a UDP packet (which includes a UDP header and a UDP payload, wherein the UDP payload includes the Load PDU to be transmitted) at the transport layer. In other words, the packets 126 have the format of UDP packets at the transport layer to meet requirements of the TR-471 speed test protocol. In this embodiment, each packet that is self-generated and sent by the packet generator circuit 122 is not larger than the Maximum Transmission Unit (MTU) of the WAN 101. Assuming that the MTU is 1024 bytes (MTU=1 KB), the packet length of each packet 126 is set by 1 KB, and the transmission parameter P2 set by the processor 114 indicates that the data amount is 64 KB. For the sake of convenience, the number of bits required by the header is not considered here. Hence, the number of packets 126 to be sent by the packet generator circuit 122 can be simply estimated to be 64 (i.e., 64 KB/1 KB=64). In addition, the rate limiter circuit 124 restricts that the packets 126 generated by the packet generator circuit 122 are sent to the network device (receiver) 102 at the sending rate (e.g., 8 Gbps) indicated by the transmission parameter P1 for network speed test (i.e., upload network speed test).

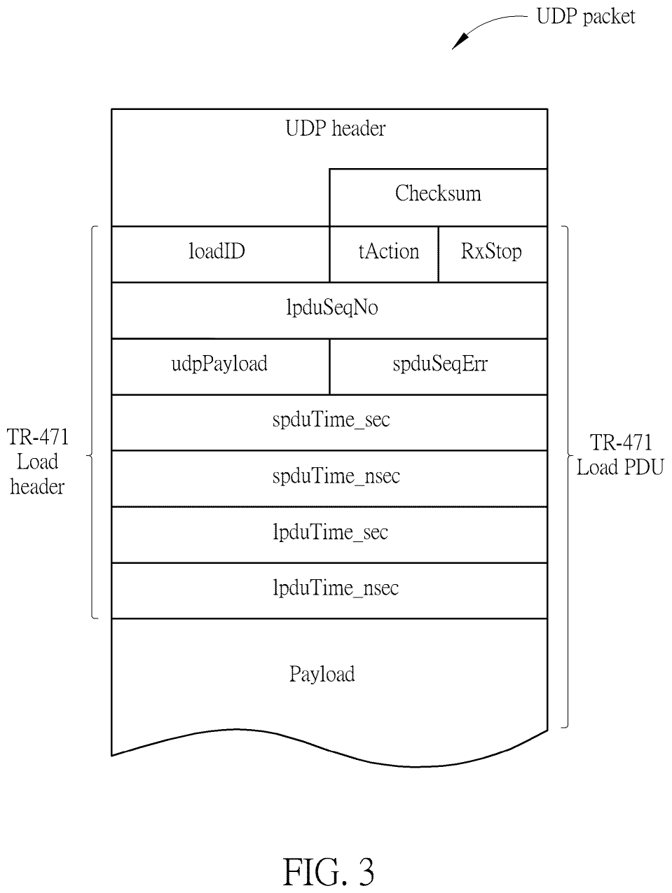

In this embodiment, the program code (e.g., Linux kernel module 118) executed by the processor 114 also generates a small number of packets (UDP packets) PKT_1 for each TI. The load header of the Load PDU carried by each packet PKT_1 provides an initial setting value for each header field. In addition, the packet PKT_1 also informs the hardware acceleration circuit 116 (particularly, packet generator circuit 122 in hardware acceleration circuit 116) of the transmission parameter P2 (e.g., 64 KB) that is set by the processor 114. In other words, the header fields in the packet PKT_1 generated by the processor 114 indicate the data amount (e.g., 64 KB) that the packet generator circuit 122 subsequently self-generates and sends. According to the TR-471 speed test protocol, the load header of the Load PDU has specific fields. As shown in FIG. 3, the “udpPayload” field has a length of 16 bits, and can be used to indicate the payload size of the UDP packet, where the UDP payload includes the load header and the payload of the Load PDU). Therefore, the maximum payload size of the UDP packet that can be indicated by the 16-bit “udpPayload” field is 64 KB. In this embodiment, the processor 114 can inform the hardware acceleration circuit 116 (particularly, packet generator circuit 122 in hardware acceleration circuit 116) of the transmission parameter P2 (e.g., 64 KB) by setting the “udpPayload” field in the packet PKT_1 that complies with the TR-471 speed test protocol.

As mentioned above, assuming that the duration of each TI is 10 ms, and the sending rate calculated by the program code (e.g., Linux kernel module 118) executed by the processor 114 for the next TI is 8 Gbps, the total data amount to be sent in the next TI is 10 MB. When the “udpPayload” field in one packet PKT_1 generated by the processor 114 indicates that the data amount is 64 KB, the packet generator circuit 122 sends a plurality of packets 126 in response to the data amount 64 KB informed by the packet PKT_1 (for example, the packet length of each packet 126 can be equal to the MTU of the network), for sending the data amount of 64KB to the network device 102. Since the total data amount to be sent in the next TI is 10 MB and the data amount indicated by the “udpPayload” field in one packet PKT_1 generated by the processor 114 is 64 KB (64 KB<10 MB), the number of packets PKT_1 to be sent by the program code (e.g., Linux kernel module 118) executed by the processor 114 in the next TI is at least 157. Regarding a conventional network device that does not employ the network speed test scheme proposed by the present invention, if the packet length of each packet is equal to the MTU of the network (e.g., MTU=1 KB), the number of packets that the processor needs to generate and send in the next TI is 10 MB/1 KB. However, regarding the network device 100 that employs the network speed test scheme proposed by the present invention, the number of packets that the processor 114 needs to generate and send in the next TI (i.e., the number of packets PKT_1 provided to the packet generator circuit 122) can be greatly reduced to 10 MB/64 KB. Since the processor 114 that generates a small number of packets PKT_1 does not consume a lot of processor resources and memory resources, the processor 114 with limited computing power can meet requirements of the upload network speed test.

According to the TR-471 speed test protocol, the load header of the Load PDU has specific fields as shown in FIG. 3. Therefore, when the packet generator circuit 122 self-generates the packets 126, it needs to fill in the correct information in each field of the load header. In this embodiment, the program code (e.g., Linux kernel module 118) executed by the processor 114 generates a small number of packets PKT_1 for each TI, and the load header of the Load PDU carried by each packet PKT_1 provides the initial setting value of each header field. Hence, the Linux kernel module 118 writes a packet descriptor of each packet PKT_1 into a transmit (TX) ring buffer 130 through the packet sending driver module 120, wherein the packet descriptor of each packet PKT_1 records the information about the actual storage address of the packet PKT_1 in the memory. In this way, the packet generator circuit 122 can subsequently read the packet descriptor of the packet PKT_1 from the TX ring buffer 130, and can refer to the storage address information provided by the packet descriptor to obtain the packet PKT_1 generated by the processor 114 from the memory through direct memory access (DMA), thereby obtaining header contents provided by the processor 114.

The packet (UDP packet) PKT_1 generated by the processor 114 is mainly used to provide the initial setting values of header fields (which include the UDP payload size indicated by the transmission parameter P2) in the load header of the Load PDU. Therefore, the packet (UDP packet) PKT_1 does not care about its own data length. Specifically, according to the network speed test scheme of the present invention, the actual packet transmission between the network devices 100 and 102 mainly includes packets self-generated by the packet generator circuit 122 according to the data amount required by the transmission parameter P2. Hence, the actual UDP payload of the packet PKT_1 generated by the processor 114 can be very small. For example, the data amount indicated by the “udpPayload” field in the packet PKT_1 provided by the processor 114 is 64 KB. However, the actual payload carried by the packet PKT_1 can be very small, such as only 10 bytes. In other words, the UDP payload of the packet (UDP packet) PKT_1 is much smaller than the data amount 64 KB indicated by the “udpPayload” field. Since the actual payload carried by the packet PKT_1 itself is very small, the processor 114 does not consume a lot of processor resources and memory resources when generating each packet PKT_1.

In summary, regarding the network device 100 employing the network speed test scheme of the present invention, the number of packets that the processor 114 needs to generate and send in the next TI (i.e., the number of packets PKT_1 provided to the packet generator circuit 122) can be greatly reduced. In addition, the actual payload carried by the packet PKT_1 itself can also be greatly reduced. In this way, during the network speed test period, the burden of the processor 114 on packet generation can be greatly relaxed, thereby enabling the processor 114 with limited computing power to meet requirements of the upload network speed test.

In this embodiment, the network device 100 offloads the packet generation task of the processor 114 to the packet generator circuit 122. That is, in response to each packet (UDP packet) PKT_1 provided by the processor 114, the packet generator circuit 122 self-generates a plurality of packets (UDP packets) 126 that can meet the required data amount (i.e., the data amount indicated by the “udpPayload” field of the packet PKT_1). In this embodiment, each of the packets 126 is not larger than the MTU of the WAN 101. Regarding packet generation, the packet generator circuit 122 copies the packet PKT_1 and performs corresponding header field content modification (which includes UDP header field modification of the UDP packet and load header field modification of the Load PDU) to generate each of the packets 126. For example, regarding the first packet 126 self-generated and sent in response to the same packet PKT_1, contents of fields, such as “loadID”, “tAction”, “rxStop”, “lpduSeqNo”, “spduTime_sec”, “spduTime_nsec”, “lpduTime_sec” and “lpduTime_nsec”, in the load header of the Load PDU can directly inherit contents of the corresponding fields in the packet PKT_1 provided by the processor 114. In addition, the payload size of the Load PDU can be set according to the MTU of the network. Therefore, the “udpPayload” field in the load header of the Load PDU needs to be filled with the corresponding correct value based on the actual data amount, rather than directly inheriting the content of the same field in the packet PKT_1 provided by the processor 114.

Regarding the second packet 126 self-generated and sent in response to the same packet PKT_1, the payload size of the Load PDU is set according to the MTU of the network. In addition to the “udpPayload” field in the load header of the Load PDU that needs to be filled with the corresponding correct value based on the actual data amount, contents of fields, such as “lpduSeqNo”, “lpduTime_sec” and “lpduTime_nsec”, in the load header of the Load PDU also need to be appropriately updated to reflect the correct values, rather than directly inheriting the contents of the same fields in the packet PKT_1 provided by the processor 114. According to the TR-471 speed test protocol, the “lpduSeqNo” field is used to record the sequence number of the Load PDU. Therefore, the packet generator circuit 122 calculates the sequence number of the Load PDU of the second packet according to the sequence number of the Load PDU of the first packet (which is equal to the sequence number of the Load PDU of the packet PKT_1 provided by the processor 114), and fills the “lpduSeqNo” field with a correct value. In addition, according to the TR-471 speed test protocol, the “lpduTime_sec” field and the “lpduTime_nsec” field are used to record the send time of this Load PDU. Therefore, the packet generator circuit 122 calculates the send time of the Load PDU of the second packet according to the send time of the Load PDU of the first packet (which is equal to the send time of the Load PDU of the packet PKT_1 provided by the processor 114) and the time actually consumed by transmission of the first packet, and fills the “lpduTime_sec” field and the “lpduTime_nsec” field with correct values.

Similarly, subsequent packets will also perform the operation of modifying contents of header fields. For example, regarding the nth (n>2) packet 126 self-generated and sent in response to the same packet PKT_1, the payload size of the Load PDU is set according to the MTU of the network. In addition to the “udpPayload” field in the load header of the Load PDU that needs to be filled with the corresponding correct value based on the actual data amount, contents of fields, such as “lpduSeqNo”, “lpduTime_sec” and “lpduTime_nsec”, in the load header of the Load PDU also need to be appropriately updated to reflect the correct values. The packet generator circuit 122 calculates the sequence number of the Load PDU of the n^{th} packet according to the sequence number of the Load of the first packet (i.e., the sequence number of the Load PDU of the packet PKT_1), and fills the “lpduSeqNo” field with a correct value. In addition, the packet generator circuit 122 calculates the send time of the Load PDU of the n^{th} packet based on the send time of the Load PDU of the first packet (i.e., the send time of the Load PDU of the packet PKT_1) and the time actually consumed by transmission of subsequent (n−2) packets, and fills the “lpduTime_sec” field and the “lpduTime_nsec” field with correct values.

For the network speed test application, the correctness of the data contents is actually not a concern. Therefore, for the packets 126 self-generated by the packet generator circuit 122, the payload of the Load PDU can be filled with random data by the packet generator circuit 122. For example, the packet generator circuit 122 can read any data from an internal memory (e.g., a static random access memory) as the payload of the Load PDU.

In addition, for a plurality of packets 126 self-generated by the packet generator circuit 122, since the packet contents are not exactly the same, the packet generator circuit 122 also needs to re-calculate the checksum for each of the plurality of packets 126 and fill it into the “checksum” field in the UDP header.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network device comprising:
a storage device, arranged to store a program code;
a processor, arranged to load and execute the program code to perform following operation:
during a network speed test period, calculating at least one transmission parameter; and
a hardware acceleration circuit, arranged to provide a function of hardware-accelerated packet processing, wherein during the network speed test period, the hardware acceleration circuit is further arranged to refer to the at least one transmission parameter to self-generate a plurality of packets and send the plurality of packets to another network device for network speed test.

2. The network device of claim 1, wherein each of the plurality of packets is a User Datagram Protocol (UDP) packet.

3. The network device of claim 2, wherein the network speed test employs a TR-471 speed test protocol.

4. The network device of claim 1, wherein the at least one transmission parameter comprises a sending rate.

5. The network device of claim 4, wherein the hardware acceleration circuit comprises:
a rate limiter circuit, arranged to restrict that the plurality of packets are sent to the another network device at the sending rate.

6. The network device of claim 1, wherein the at least one transmission parameter comprises a data amount.

7. The network device of claim 6, wherein the processor is further arranged to execute the program code to perform following operation:
generating a packet, and write a packet descriptor of the packet into a transmit (TX) ring buffer, wherein a header field of the packet indicates the data amount;
the hardware acceleration circuit is further arranged to read the packet through the TX ring buffer, and determine a number of the plurality of packets according to the data amount indicated by the header field.

8. The network device of claim 7, wherein the data amount indicated by the header field is larger than a maximum transmission unit (MTU) of a network, and payload of the packet is smaller than the data amount indicated by the header field.

9. The network device of claim 7, wherein the hardware acceleration circuit comprises a packet generator circuit arranged to copy the packet and perform header field content modification, to generate each of the plurality of packets.

10. The network device of claim 1, wherein the network device is an optical network unit (ONU).

11. A network speed test method comprising:
executing a program code to calculate at least one transmission parameter; and
using a hardware acceleration circuit with a function of hardware-accelerated packet processing for referring to the at least one transmission parameter to self-generate a plurality of packets and send the plurality of packets to another network device for network speed test.

12. The network speed test method of claim 11, wherein each of the plurality of packets is a User Datagram Protocol (UDP) packet.

13. The network speed test method of claim 12, wherein the network speed test employs a TR-471 speed test protocol.

14. The network speed test method of claim 11, wherein the at least one transmission parameter comprises a sending rate.

15. The network device of claim 14, wherein referring to the at least one transmission parameter to self-generate the plurality of packets and send the plurality of packets to the another network device for the network speed test comprises:
restricting that the plurality of packets are sent to the another network device at the sending rate.

16. The network speed test method of claim 11, wherein the at least one transmission parameter comprises a data amount.

17. The network speed test method of claim 16, further comprising:
executing the program code to generate a packet and write a packet descriptor of the packet into a transmit (TX) ring buffer,
wherein a header field of the packet indicates the data amount; wherein referring to the at least one transmission parameter to self-generate the plurality of packets and send the plurality of packets to the another network device for the network speed test comprises:
reading the packet through the TX ring buffer; and
determining a number of the plurality of packets according to the data amount indicated by the header field.

18. The network speed test method of claim 17, wherein the data amount indicated by the header field is larger than a maximum transmission unit (MTU) of a network, and payload of the packet is smaller than the data amount indicated by the header field.

19. The network speed test method of claim 17, wherein referring to the at least one transmission parameter to self-generate the plurality of packets and send the plurality of packets to the another network device for the network speed test further comprises:
copying the packet and performing header field content modification, to generate each of the plurality of packets.

20. The network speed test method of claim 11, wherein the network speed test method is performed by an optical network unit (ONU).
